(19) United States
(12) Patent Application Publication
(10) Pub. No.: US 2017/0363266 A1
(43) Pub. Date: Dec. 21, 2017

(54) OPTICAL UNIT FOR A HEADLIGHT, OPTICS ARRANGEMENT AND HEADLIGHT

(71) Applicant: OSRAM GmbH, Munich (DE)

(72) Inventors: Thomas Feil, lggingen (DE); Daniel Weissenberger, Giengen (DE)

(21) Appl. No.: 15/622,160

(22) Filed: Jun. 14, 2017

(30) Foreign Application Priority Data
Jun. 15, 2016 (DE) 10 2016 210 636.8

(51) Int. Cl. F21S 8/10; F21Y 101/00; F21Y 2115/10

(52) U.S. Cl. CPC F21S 48/1394; F21S 48/125; F21S 48/1736; F21Y 2115/10; B60Q 2300/05; F21Y 2101/00

(57) ABSTRACT

In various embodiments, an optical unit is provided. The optical unit includes a first optics element which act as a lens and is made of silicone, and a second optics element. The second optics element is arranged in the first optics element that is formed from an at least one of harder or stiffer material as compared to the first optics element.

### CROSS-REFERENCE TO RELATED APPLICATION

This application claims priority to German Patent Application Serial No. 10 2016 210 636.8, which was filed Jun. 15, 2016, and is incorporated herein by reference in its entirety.

### TECHNICAL FIELD

Various embodiments relate generally to an optical unit for a headlight for a vehicle. Various embodiments furthermore relate to an optics arrangement having an optical unit of this type and to a headlight for a vehicle having an optical unit of this type. Various embodiments furthermore provide a manufacturing method for an optical unit of this type.

### BACKGROUND

Conventional matrix systems, for example for front headlights of a vehicle, may make possible adaptive driving beam applications (ADB applications) or adaptive frontlighting system applications (AFS applications). In a matrix system, for example a multiplicity of light-emitting diodes (LEDs) are arranged in a headlight in the manner of a matrix, which are separately drivable and as a result can be switched on and off and also dimmed. Consequently, opposing and preceding vehicles can be detected and at least regionally shaded, for example in combination with a camera system and an image-processing electronic system. However, in peripheral regions of a lit region, e.g. in peripheral regions of shaded segments or switched-off LEDs, color fringes may occur in a disadvantageous manner. Alternatively or additionally to LED light sources, laser light sources can be used, in which a blue laser beam is partially converted into yellow conversion light using a conversion element (phosphor), with the result that, upon superposition of unconverted blue laser light and yellow conversion light, white mixed light (used light) is obtained. The color coordinates of the white mixed light should here be within the standardized ECE white field according to the regulation ECE/324/Rev.1/Add.47/Reg.No. 48/Rev.12.

### SUMMARY

In various embodiments, an optical unit is provided. The optical unit includes a first optics element which act as a lens and is made of silicone, and a second optics element. The second optics element is arranged in the first optics element that is formed from an at least one of harder or stiffer material as compared to the first optics element.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A and 1B show a perspective view and a side view of an optical unit according to a first embodiment;

FIGS. 2A and 2B show a perspective view and a side view of the optical unit according to a second embodiment;

FIGS. 3A and 3B show a perspective view and a side view of the optical unit according to a third embodiment;

FIGS. 4A and 4B show a perspective view and a side view of the optical unit according to a fourth embodiment;

FIGS. 5A and 5B show a side view and a perspective view of a headlight for a vehicle according to an embodiment; and

FIG. 6 shows a flowchart of a production method according to an embodiment.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide an optical unit and an optics arrangement, e.g. for a headlight, which have a simple construction in terms of apparatus technology and a high strength and/or deflect light beams with a relatively high accuracy. Furthermore, various embodiments provide a headlight for a vehicle that has a low weight and emits light with a high accuracy. Furthermore, various embodiments provide a cost-effective method for producing an optical unit.

Various configurations can be found in the dependent claims.

Various embodiments provide an optical unit, e.g. for a headlight or a vehicle headlight or a vehicle lamp. This optical unit has a first optics element acting as a lens or a first optics component acting as a lens. The optics element may be at least partially or substantially completely or completely made of silicone, which is suitable for use in optical elements, i.e. is characterized for example by a resistance to radiation, e.g. blue radiation, and has a good sealing function. For example, the silicone of type Lumisil LR 7600/70 from Wacker can be used for this purpose. Furthermore, a second optics element may be arranged in the first optics element, wherein the second optics element is made of a harder material as compared to silicone, i.e. e.g. has a greater stiffness with respect to mechanical deformation.

This solution may have the effect that the first optics element can be used to refract light with high accuracy, and the optical unit can be manufactured cost-effectively and easily as compared to an optical unit that is made entirely of glass. Furthermore, the optics element made of silicone can be shaped as desired with little complexity in terms of apparatus technology, for example by injection molding, and thus have any desired freeforms, as a result of which, for example even undercuts, e.g. in dependence on the material, are made possible. Owing to the harder second optics element, the optical unit furthermore has a high stability and yet a low weight. In other words, the solution may have the effect that the optical unit is not made of glass, as is customary, but of silicone having an inlay that is made of a harder material and increases the stiffness. The harder material inside the optical unit thus increases the stiffness of the total system, which facilitates installation, for example in a vehicle headlight, and compensates for a low hardness of the silicone. It may furthermore be provided that the first optics element serves as a spring element to absorb impacts during use of the optical unit. It may also be provided that the first optics element, which is made of silicone, is resistant in terms of temperature and UV light, as a result of which no ageing or substantially no ageing occurs as compared to conventionally used optical plastics, which are made for example of polycarbonate (PC) or polymethyl methacrylate (PMMA). Furthermore, a significant weight reduction may be achieved owing to the silicone.

As a result, for example an input-coupling and output-coupling surface of the first optics element can be formed by silicone. The second optics element may furthermore be arranged in a beam path that extends through the first optics element.

The vehicle can be an aircraft or a water-bound vehicle or a land-bound vehicle. The land-bound vehicle can be a motor vehicle or a rail vehicle or a bicycle. Various embodiments may provide for the use of the vehicle headlight in a truck or passenger car or motor bicycle.

It may be provided that the second optics element is made at least partially or substantially completely or completely of glass, e.g. glass which has a high light transmittance and an Abbe number that differs with respect to the silicone. Furthermore, it is possible with the glass to cost-effectively and simply increase the mechanical stiffness of the optical unit.

The second optics element may likewise be configured in the form of a lens or is a lens. Consequently, the optical unit can have two lenses in a simple manner. The second optics element can thus be used for increasing a strength for the optical unit and additionally deflect light at least at one surface by way of refraction. If the second optics element is not in the form of a lens, it may at least be used for increasing the strength.

If the optical unit is configured as an achromatic lens, then in addition to the effects explained above, it can reduce or prevent the color fringes occurring in peripheral regions, as explained in the introductory part. Such color fringes are caused by dispersion of the imaging optical unit, i.e. in dependence on the refractive index of the wavelength of the light. To avoid color fringes, a color correction must thus be carried out, which is done by the achromatic lens. Conventional achromatic lenses are very costly and have a great weight, which makes them unattractive for use in vehicles. If the optical unit is in the form of an achromatic lens, use in a vehicle therefore makes technical and economic sense. Since a lens of the achromatic lens is made of silicone, it is thus less costly than an achromatic lens that consists entirely of glass.

The second optics element may be substantially completely or completely surrounded by the first optics element, as a result of which at least a form-fitting connection is achieved and, for example, no additional adhesive is necessary. In other words, the glass lens is encompassed completely by silicone, e.g. without air inclusion. This ensures that the glass and the silicone remain in mechanical contact, since ingress of air in the region of the boundary surface is not possible. Alternatively or additionally, provision may be made for one or more points at which one or more holding elements is/are arranged to be subsequently sealed, for example by potting.

In a further configuration, the second optics element is assigned a holding structure, e.g. at the peripheral region thereof, and/or the holding structure is connected to the second optics element. As a result, exact positioning of the second optics element e.g. in a silicone injection molding tool, for example during manufacturing, is made possible. The holding structure is, for example, a plastics or sheet metal retainer. One or more elements that is/are elastic and/or repel silicone can also be provided as the holding structure to position the second optical element in the injection molding tool. It is likewise feasible for one or more, e.g. elastic, pins to be provided as the holding structure. Said pins can be placed for example onto mandrels in the injection molding tool.

The holding structure, e.g. the pins, can then be surrounded by silicone during an injection molding method, as a result of which it forms part of the optical unit. The holding structure, e.g. the pins, can then be used for the purposes of referencing or attachment of the optical unit in the vehicle headlight.

In a further configuration, it is feasible for the second optics element to have one or more cutouts or holes, e.g. in the peripheral region. As a result, further form-fitting connections can be created between the first and second optics elements in order to impede elongation effects, e.g. thermal elongation effects, of the silicone in order to minimize changes in the optical imaging.

A sealing collar made of silicone may be formed at a periphery which surrounds the large areas of the optical unit. This sealing collar can be used as a seal between the optical unit and an optics holder, for example in the vehicle headlight.

If the optical unit is configured as an achromatic lens, the first optics element can be configured to be, for example, planoconvex and/or biconvex and/or biconcave (with respect to its outer geometry), and the second optics element can be configured to be biconvex. Input-coupling surfaces of the optics elements may be arranged with approximately parallel spacing with respect to one another, as a result of which the first optics element has an approximately constant thickness in this region. It is furthermore conceivable for output-coupling surfaces of the optics elements to have a greater spacing with respect to one another than the input-coupling surfaces, and e.g. for the first optics element to have a non-constant thickness in this region. Different lens forms should likewise be possible, for example the first optics element can be planoconvex and the second optics element can be planoconcave.

If the second optics element is not in the form of a lens, but serves only to reinforce the optical unit, the second optics element can be preferably in the form of an approximately planar plate. As a result, the optical unit only has input-coupling and output-coupling surfaces made of silicone which are freely shapable. The second optics element or the glass plate may be completely enclosed in the first optics element. The first optics element in this case is configured to be biconvex, for example. In addition, the first and/or second optical element can have anti-reflection coatings.

If the optical unit is in the form of an apochromatic lens, e.g. a third optics element is arranged in the first optics element. The third optics element may likewise be at least partially or substantially completely or completely made of glass. Furthermore, the materials of the second and third optics elements may differ from one another. As a result, glass lenses can be made of different, suitable glasses. In the case of three optics elements, the first optics element may act as a lens between the second and third optics elements. As a result, the region between the glass lenses that is filled with silicone can form a third lens. The second and third optics elements may have the same configuration. In various embodiments, the second and third optics elements are configured to be biconvex. The second and third optics elements, that is to say the two glass lenses, may form a preassembled unit. In various embodiments, they can here be pre-fixed with respect to one another by way of a holding structure or a holding apparatus and thus be placed together into the injection molding tool.

In various embodiments, a matrix or an array of second optics elements is provided which are surrounded by a matrix or of an array of first optics elements. A respective second optics element can then be assigned a respective first optics element. An optical unit of this type is usable for example for matrix systems in front headlights. The second optics elements are, for example, configured to be joined together and can form, for example, a one-piece glass plate. A respective second optics element is then provided within the glass plate as a single glass lens. It is also conceivable to mechanically connect the second optics elements not as one piece, but in another way. If the second optics elements are connected or formed as one piece with one another, they can be placed in the form of a composite into the injection molding tool in a manner which is simple in terms of apparatus technology. The first optics element can completely surround the second optics elements. Consequently, the matrix of first optics elements is configured to be in one piece. The optical unit can then be in the form of a block. If the optical unit, which is configured in the form of a matrix, is used as an achromatic lens, then with respect to its first optics elements it may have a multiplicity of convex input-coupling surfaces, which are in each case assigned to a respective second optics element, wherein the second optics elements can in each case be configured to be biconvex. Output-coupling surfaces of the first optics elements can be configured to be approximately concave.

In various embodiments, the optical unit is configured or designed such that optical imaging is optimum at an application temperature that is typical or conventional or average for its purpose, for example in the temperature range of −40° C. to +125° C. that is relevant for the motor vehicle field. As a result, temperature compensation is provided in a simple manner, because silicone has a relatively high thermal expansion and a dependence of a refractive index on the temperature.

In various embodiments, an optics arrangement having an optical unit according to one or more of the preceding aspects is provided. The optics arrangement here may have cooling and/or heating. High accuracy of optical imaging of the optical unit at a wide range of temperatures is thus ensured. Cooling and/or heating may be effected by convection, for example by way of a warm or cold air flow, but may also include other heating or cooling elements, such as for example electrical resistance heating wires, conductive ITO coatings, Peltier elements, infrared emitters etc. The heating or cooling elements can also be surrounded by the silicone. Alternatively or additionally, it is conceivable for a position adjustment device, for example position determination by way of photodetectors, in connection with successive readjustment, e.g. along the optical axis, i.e. along the beam direction, to be provided for the optical unit. As a result, readjustment of the position of the optical unit or of the lens system along the optical axis can be effected in order to optimally set a focal point of the system, if the latter changes, for example in dependence on the temperature.

Provided according to various embodiments is a headlight for a vehicle having an optical unit according to one or more of the preceding aspects. The optical unit may be arranged downstream of one or more radiation sources.

The at least one radiation source can be configured in the form of a semiconductor light source or a light-emitting diode (LED), e.g. an LED in which a portion of blue primary radiation is converted into yellow conversion light using conversion phosphor, and/or an organic LED (OLED), and/or a laser diode and/or a light-emitting means operating on the principle of a laser activated remote phosphor (LARP), and/or a halogen lamp and/or a gas-discharge lamp (HID) and/or a projector operating on the principle of digital light processing (DLP). As a result, a large number of alternatives for a light source are available.

A light-emitting diode (LED) can be present in the form of at least one individually packaged LED or in the form of at least one LED chip having one or more light-emitting diodes. A plurality of LED chips can be mounted on a common substrate (“submount”), and form an LED, or be attached individually or together for example on a printed circuit board (e.g. FR4, metal core PCB etc.) (“CoB”=chip on board). The at least one LED can be fitted with at least one dedicated and/or shared optical unit for beam guidance, for example with at least one Fresnel lens or a collimator. Instead of or in addition to inorganic LEDs, for example on the basis of InGaN or AlInGaP, generally also organic LEDs (OLEDs, e.g. polymer OLEDs) can be used. The LED chips can be directly emitting or have a phosphor arranged upstream. Alternatively, the LED can be a laser diode or a laser diode array. Likewise conceivable is the provision of an OLED light-emitting layer or a plurality of OLED light-emitting layers or an OLED light-emitting region. The emission wavelengths of the LED can be in the ultraviolet, visible or infrared spectral range. The LED chips preferably emit white light in the standardized ECE white field of the motor vehicle industry.

In the headlight, a primary optical unit is provided between the optical unit according to various embodiments and the radiation sources e.g. for a respective radiation source or for some of the radiation sources or for all radiation sources, wherein the optical unit according to various embodiments can then form a secondary optical unit.

If LEDs are used, the spectrum of which has a respective peak in the blue and in the yellow spectral ranges, it may be provided to design the optical unit as an achromatic lens such that focal widths for both peak wavelengths are substantially identical or identical.

The headlight can be, for example, part of an adaptive frontlighting system (AFS) or an adaptive driving beam application (ADB).

Further areas of use can be, for example, headlights for effect lighting, entertainment lighting, architainment lighting, ambient lighting, medical and therapeutic lighting, horticulture etc.

In a method according to various embodiments for producing an optical unit according to one or more of the preceding aspects, the following processes may be provided:
arranging the second optics element or the glass in an injection molding tool, e.g. via its holding structure,
injecting silicone around the second optics element for forming the first optics element.

The optical unit can thus be produced cost-effectively with such a method. Due to the injection molding production, no additional contact agent or adhesive for connecting the optics elements is necessary.

In the method, a sealing collar can be molded onto the periphery surrounding the large surfaces of the optical unit. This takes place for example during the embedding of the second optics element or in an additional method process.

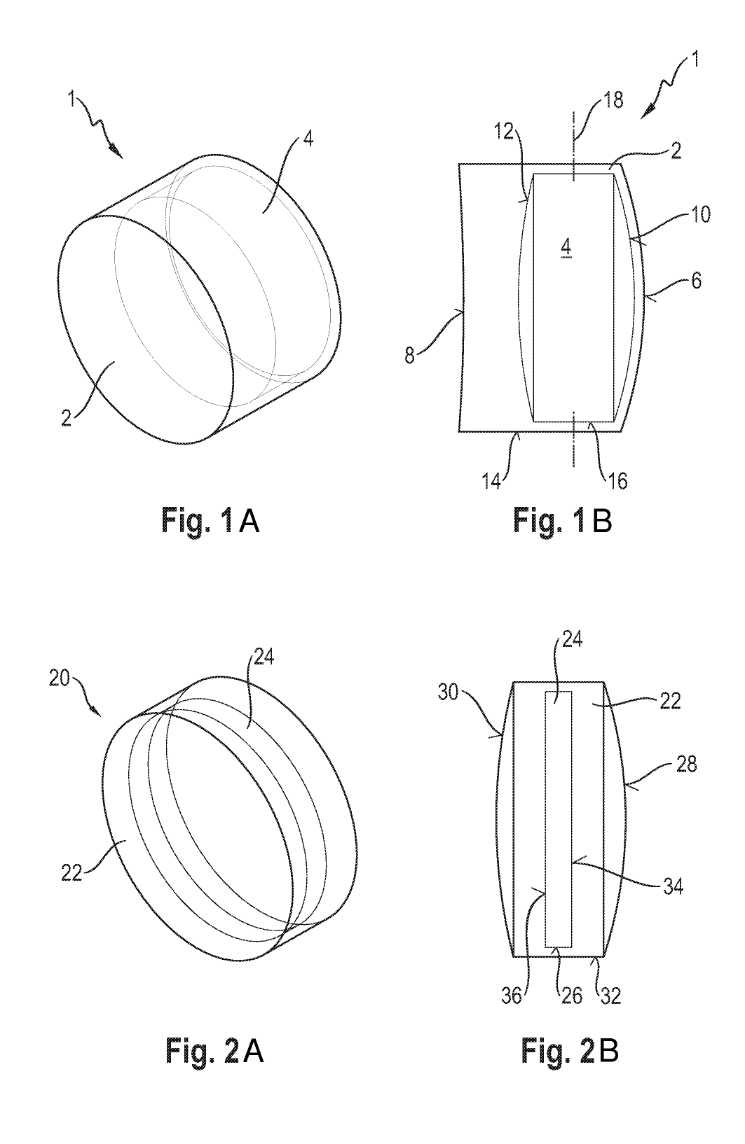

According to FIG. 1A, the optical unit 1 has a first optics element 2 and a second optics element 4. The optical unit 1 is here in the form of an achromatic lens. The first optics element 2 here consists substantially entirely of silicone. In contrast, the second optics element 4 is substantially made of glass. The second optics element 4 is furthermore arranged as an inlay in the first optics element 2, and is thus completely surrounded and enclosed by the first optics element 2. The holding elements or holding points which are optionally usable for the injection process are not illustrated in the figures.

According to FIG. 1B, the first optics element 2 of the optical unit 1 has a convex input-coupling surface 6 and a slightly concave output-coupling surface 8 (in the case of the irradiation from the right-hand side present here). The input-coupling surface 10, which is provided downstream of the input-coupling surface 6 as viewed in the radiation direction, of the second optics element 4 is likewise of convex configuration. An output-coupling surface 12 of the second optics element 4 is also convex. A spacing between the input-coupling surfaces 6 and 10 is at least substantially identical, as a result of which the first optics element 2 has an approximately constant thickness and/or a substantially identical radius of curvature in the beam path between the input-coupling surfaces 6 and 10. A lateral surface 14 or a periphery of the first optics element 2 has a substantially circular cylindrical cross section. The same is true of a lateral surface 16 or a periphery of the second optics element 4. However, a diameter of the lateral surface 16 is smaller than a diameter of the lateral surface 14, and as a result, the second optics element 4 is enclosed by the first optics element 2. The optics elements 2 and 4 may be arranged approximately coaxially with respect to one another. A spacing between the output-coupling surfaces 8 and 12 is greater than a spacing between the input-coupling surfaces 6 and 10.

FIG. 1B schematically illustrates a holding structure 18 by way of a dash-dot line. This holding structure can be used to position and hold the second optics element 4 in an injection molding tool. After production, the holding structure 18 can form part of the optical unit 1.

An optical unit 20 according to FIG. 2A likewise has a first optics element 22 and a second optics element 24. According to FIG. 2B, the second optics element 24 is configured approximately as a planar plate and has a lateral surface 26 with an approximately circular cylindrical cross section. The second optics element 24 thus does not serve as a lens, but is a mechanical reinforcement for the optical unit 20. The first optics element 22 is of biconvex configuration with a convex input-coupling surface 28 and a convex output-coupling surface 30, which are surrounded by a lateral surface 32 having an approximately circular cylindrical cross section. A spacing between an optics surface 34 of the second optics element 24, which faces the input-coupling surface 28, and the input-coupling surface 28 is greater than a spacing between an optics surface 36 of the second optics element 24, which faces the output-coupling surface 30, and the output-coupling surface 30.

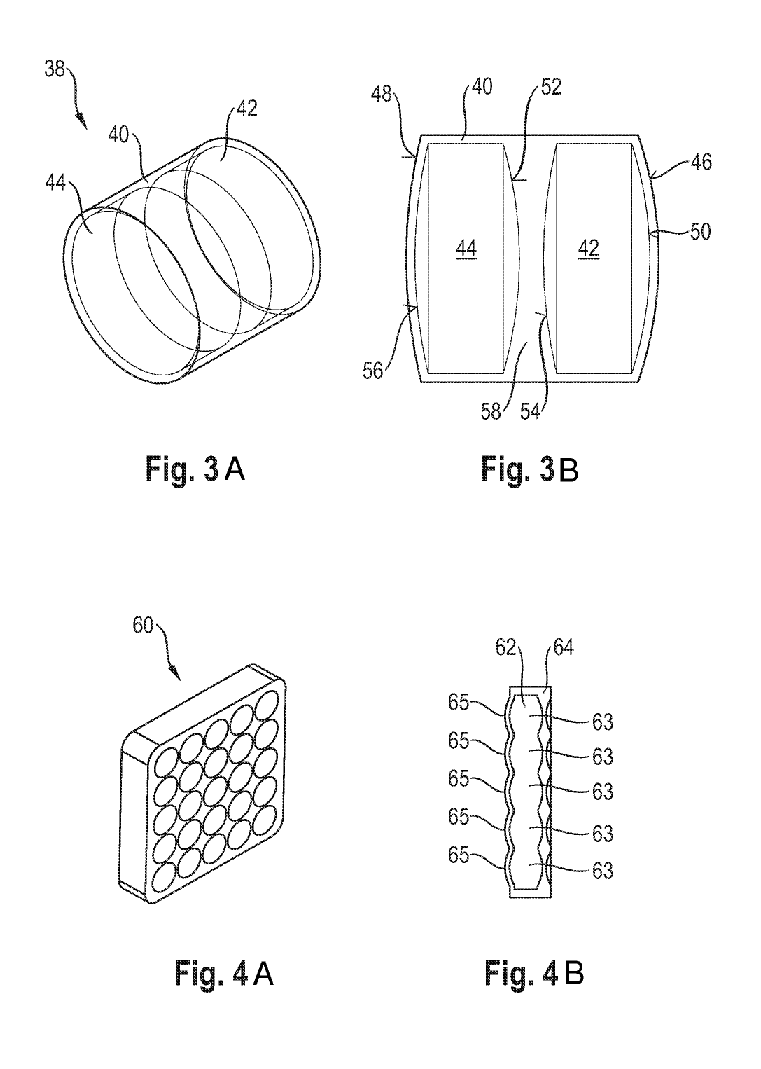

According to FIG. 3A, an optical unit 38 has a first optics element 40, in which a second optics element 42 and a third optics element 44 are placed. The optical unit 38 is an apochromatic lens. The optics elements 42 and 44 here are substantially entirely made of glass.

According to FIG. 3B, outer optics surfaces 46 and 48 of the first optics element 40 each have a convex configuration. The optics elements 42 and 44 are each of biconvex configuration with in each case one convex input-coupling surface 50, 52 and in each case one convex output-coupling surface 54, 56.

Between the input-coupling surface 52 of the optics element 44 and the output-coupling surface 54 of the optics element 42, the first optics element 40, which is substantially made of silicone, forms a lens 58.

According to FIG. 3B, a thickness between the optics surface 46 and the input-coupling surface 50 is identical. Furthermore, a thickness between the optics surface 48 and the output-coupling surface 56 is in each case identical. The thicknesses per se can likewise be identical.

The diameters of the optics elements 40 and 42 according to FIG. 3B are substantially identical and smaller than the diameter of the optics element 40.

FIG. 4A illustrates a matrix-type optical unit 60. This optical unit according to FIG. 4B is formed by a matrix 62 of second optics elements 63, which are surrounded by a matrix 64 of first optics elements 65. The second optics elements 63 are here of one-piece design. They each have a biconvex shape. The first optics elements 65 are likewise configured to be joined together or in one piece and each have a convex input-coupling surface and a concave output-coupling surface (in the case of the irradiation present here from the left-hand side). A respective second optics element 63 here forms, together with the respectively assigned first optics element 65, an achromatic lens.

According to FIG. 4A, the optical unit 60 is of approximately block-shaped design.

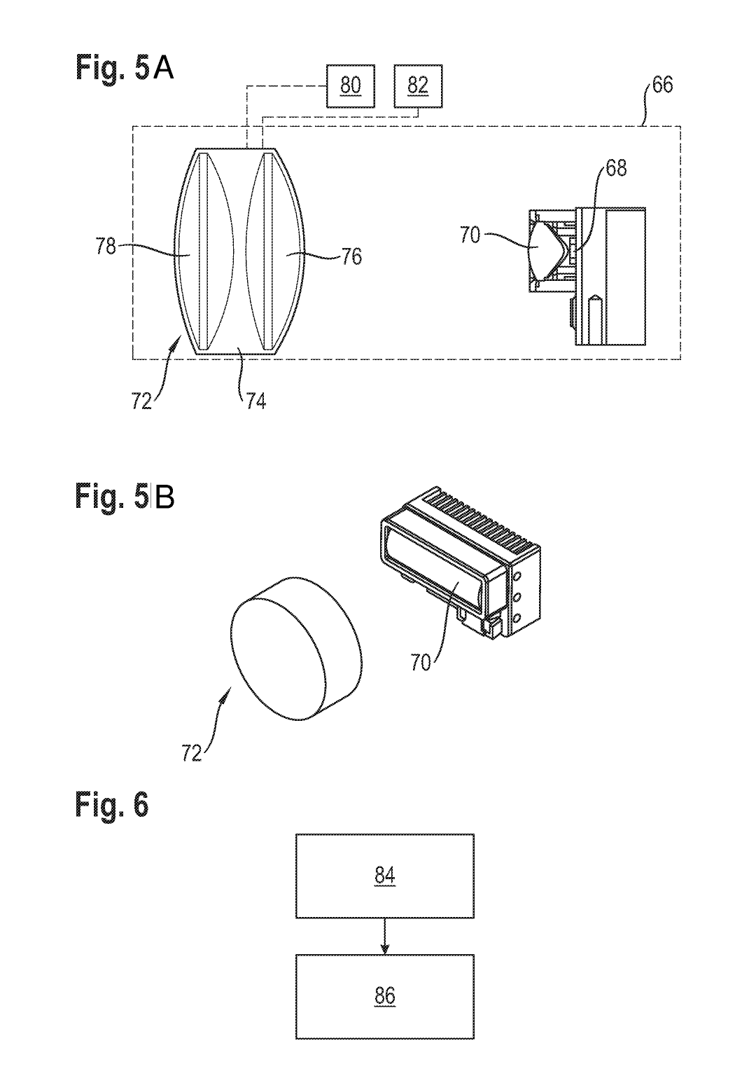

FIG. 5A illustrates a headlight 66 for a vehicle. Here, a row of radiation sources 68, for example light-emitting diodes (LEDs), is arranged, and a primary optical unit 70 is arranged downstream thereof, see also FIG. 5B. The primary optical unit 70 is here of elongate design, and the radiation sources 68 extend approximately in a horizontal direction. Provided downstream of the primary optical unit 70 is an optical unit 72, which has a first optics element 74, a second optics element 76 and a third optics element 78. The optical unit 72 here approximately corresponds to the optical unit 38 from FIG. 3A and FIG. 3b. To keep the temperature of the optical unit 72 substantially constant, cooling and heating means 80 are provided in the headlight 66, which are illustrated schematically in FIG. 5A. Alternatively or additionally, a position adjustment device 82 for the optical unit 72 is configured in the headlight 66, which is likewise illustrated schematically.

FIG. 6 shows a method for producing an optical unit. In 84, a second optics element, which is at least substantially made of glass, is arranged in this case in an injection molding tool, wherein a holding structure can be provided herefor. In 86, silicone is injected around the second optics element, as a result of which the first optics element is formed and the second optics element forms an inlay.

In the embodiments explained above, the input-coupling surfaces 10, 28, 50 and 52 each have a smaller radius of curvature than the assigned output-coupling surfaces 12, 30, 54 and 56.

Disclosed is an optical unit for a vehicle headlight, which is formed in one part from silicone and in the other part from a harder material. The other part may be surrounded by silicone.

Various embodiments provide an optical unit for a vehicle headlight, which is formed in one part from silicone and in the other part from a harder material. The other part is here surrounded by silicone.

### LIST OF REFERENCE SIGNS

optical unit 1
first optics element 2
second optics element 4
input-coupling surface 6
output-coupling surface 8
input-coupling surface 10
output-coupling surface 12
lateral surface 14
lateral surface 16
holding structure 18
optical unit 20
first optics element 22
second optics element 24
input-coupling surface 28
output-coupling surface 30
lateral surface 32
optics surface 34
optics surface 36
optical unit 38
first optics element 40
second optics element 42
third optics element 44
optics surface 46
optics surface 48
input-coupling surface 50
input-coupling surface 52
output-coupling surface 54
output-coupling surface 56
lens 58
optical unit 60
matrix 62
second optics element 63
matrix 64
first optics element 65
headlight 66
primary optical unit 70
optical unit 72
first optics element 74
second optics element 76
third optics element 78
cooling and heating means 80
position adjustment device 82
process 84
process 86

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An optical unit, comprising:
a first optics element which act as a lens and is made of silicone; and
a second optics element, wherein the second optics element is arranged in the first optics element that is formed from an at least one of harder or stiffer material as compared to the first optics element.

2. The optical unit of claim 1,
wherein the second optics element is formed at least partially from glass.

3. The optical unit of claim 1,
wherein the second optics element acts as a lens.

4. The optical unit of claim 1,
wherein the optical unit is an achromatic lens or an apochromatic lens.

5. The optical unit of claim 1,
wherein the second optics element is substantially completely or completely surrounded by the first optics element.

6. The optical unit of claim 1,
wherein the second optics element is assigned a holding structure.

7. The optical unit of claim 1,
wherein a matrix or an array of second optics elements is provided which is surrounded by a matrix or by an array of first optics elements,
wherein a respective second optics element is assigned a respective first optics element.

8. An optics arrangement, comprising:
an optical unit, comprising:
a first optics element which act as a lens and is made of silicone; and
a second optics element, wherein the second optics element is arranged in the first optics element that is formed from an at least one of harder or stiffer material as compared to the first optics element;
wherein one of the following group is provided, the group consisting of:
a coupling structure for the optical unit;
a heating structure for the optical unit; and
a position adjustment device for the optical unit.

9. A headlight for a vehicle, the headlight comprising:
an optical unit, comprising:
a first optics element which act as a lens and is made of silicone; and
a second optics element, wherein the second optics element is arranged in the first optics element that is formed from an at least one of harder or stiffer material as compared to the first optics element.

10. A headlight for a vehicle, the headlight comprising:
optics arrangement, comprising:
an optical unit, comprising:
a first optics element which act as a lens and is made of silicone; and
a second optics element, wherein the second optics element is arranged in the first optics element that is formed from an at least one of harder or stiffer material as compared to the first optics element;
wherein one of the following group is provided, the group consisting of:
a coupling structure for the optical unit;
a heating structure for the optical unit; and
a position adjustment device for the optical unit.

11. A method for producing an optical unit,
the optical unit comprising:
a first optics element which act as a lens and is made of silicone; and
a second optics element, wherein the second optics element is arranged in the first optics element that is formed from an at least one of harder or stiffer material as compared to the first optics element;
the method comprising:
arranging the second optics element in an injection molding tool;
injecting silicone around the second optics element.
